(19) United States
(12) Patent Application Publication
(10) Pub. No.: US 2006/0005125 A1
(43) Pub. Date: Jan. 5, 2006

(54) Determing file icons for terminal display

(76) Inventor: Erika Reponen, Tampere (FI)

Correspondence Address: PERMAN & GREEN, 425 POST ROAD, FAIRFIELD, CT, 06824, US

(21) Appl. No.: 11/158,935

(22) Filed: Jun. 22, 2005

(30) Foreign Application Priority Data
Jul. 5, 2004 (FI) 20045265

(51) Int. Cl. G06F 17/21

(52) U.S. Cl. 715/517; 715/522; 715/908

(57) ABSTRACT

A method for determining in a terminal device file icons to be presented on a display, in which method at least two file icons are determined for a template-based file used by the terminal device. Graphical appearance of the icon representing an unmodified template is arranged to be uniform with all unmodified template icons of the terminal device. When the icon is shown on the display, it is checked whether the file corresponding to the file icon is a template-based file, in which changes have been made. If the file is a template file, in which no changes have been made, an icon representing said unmodified template is updated on the display. Otherwise a file icon, which deviates from the graphical appearance of an unmodified template icon, is updated on the display.

### FIELD OF THE INVENTION

The invention relates to graphical user interfaces, in particular to determination of file icons to be presented on the display of a terminal.

### BACKGROUND OF THE INVENTION

The user interfaces of most data processing devices, such as computers, mobile stations and PDA devices, have been implemented by means of graphical icons. The applications and files of a terminal device are started and processed by pointing out a desired icon with a pointing means, such as a mouse, of the terminal device and by activating the application or the file underlying the icon with a start button of the pointing means, such as a mouse button.

Various document applications of the terminal device, such as word processing, spreadsheet and presentation graphics applications, enable the use of templates as means to create document files. Various message applications, such as email programs and multimedia message applications (MMS) may also comprise message templates, which will also be referred to as templates herein. A template serves as a model for a document file or a message such that the template includes formatting definitions for document layout and typically some predetermined information fields (text, graphics, etc.). The template may also include selection menus and macros, which update various fields in the document file on the basis of data the user has entered in input fields. Thus, a template typically comprises predetermined fields, which the user cannot modify, and in addition thereto fields that can be modified by the user.

When a template is modified such that the user feeds information in user-modifiable fields, the file is typically stored in a file format that differs from a template format. Thus the template itself remains unmodified and consequently the same template definitions are usable next time. The prior art graphical user interfaces have a drawback, however, that the user interface settings do not provide clear alternatives to visually distinguish between templates and document files. Typically templates relating to different applications are presented by means of icons whose graphical appearances are application-specific. Hence, a wide variety of icons are used for presenting templates, whereby it is difficult to find templates and distinguish them from document files, which undermines the usability of the terminal device and the applications thereof.

### BRIEF DESCRIPTION OF THE INVENTION

Now there is developed a procedure, by means of which drawbacks of the above problems can be reduced in graphical user interfaces of terminal devices. Various aspects of the invention provide a method, a device and a software product, which are characterized by what is stated in the independent claims. The preferred embodiments of the invention are disclosed in the dependent claims.

The procedure according to the invention for determining file icons presented on a display in a terminal device is based on initially determining a first icon for a file created with said application. After that for the template-based file created with said application there is determined at least one second icon which represents an unmodified template and whose graphical appearance comprises a common feature with an icon representing an unmodified template of at least one second application. Thereafter, when a display of the terminal device is updated (for instance, when the terminal device is started or when a new window is opened on the display), it is checked whether the file corresponding to the file icon shown on the display is a template-based file with modifications made thereto. If a template file without modifications is concerned, an icon representing said unmodified template is updated on the display. Otherwise a first file icon, which deviates from the graphical appearance of the icon representing an unmodified template, is updated on the display.

According to one embodiment said icon representing an unmodified template is presented comprising a dashed line substantially around the icon.

According to one embodiment said icon representing an unmodified template is produced by adding a dashed line around any one predetermined file icon.

Considerable advantages are achieved with the arrangement of the invention. An advantage is that thanks to a uniform graphical appearance template icons can be visualized and easily distinguished from other icons, which provides improved usability of the terminal device. A further advantage is that when the graphical appearance of the template icons is made uniform in accordance with one embodiment by adding a unifying feature, such as a dashed line, to the existing icons, there will be no need to design template icons separately, but a visual template icon is provided by automated graphical modification.

### BRIEF DESCRIPTION OF THE DRAWINGS

In the following the invention will be described in greater detail in connection with preferred embodiments, with reference to the attached drawings, wherein

FIG. 1 shows a wireless terminal device, to which the invention can be applied;

FIG. 2 shows a flow chart of a method in accordance with an embodiment of the invention; and

FIGS. 3a, 3b and 3c show examples of graphical icons in accordance with some embodiments of the invention.

### DETAILED DESCRIPTION OF THE INVENTION

It is possible to utilize the procedure for determining file icons of the invention and the relating file icons in any terminal device that comprises a graphical user interface. For instance, the terminal device may be a tabletop computer comprising a Windows®- or Linux®-based operating system or it may be a mobile station or a so-called PDA device having the Symbian or Palm®OS operating system.

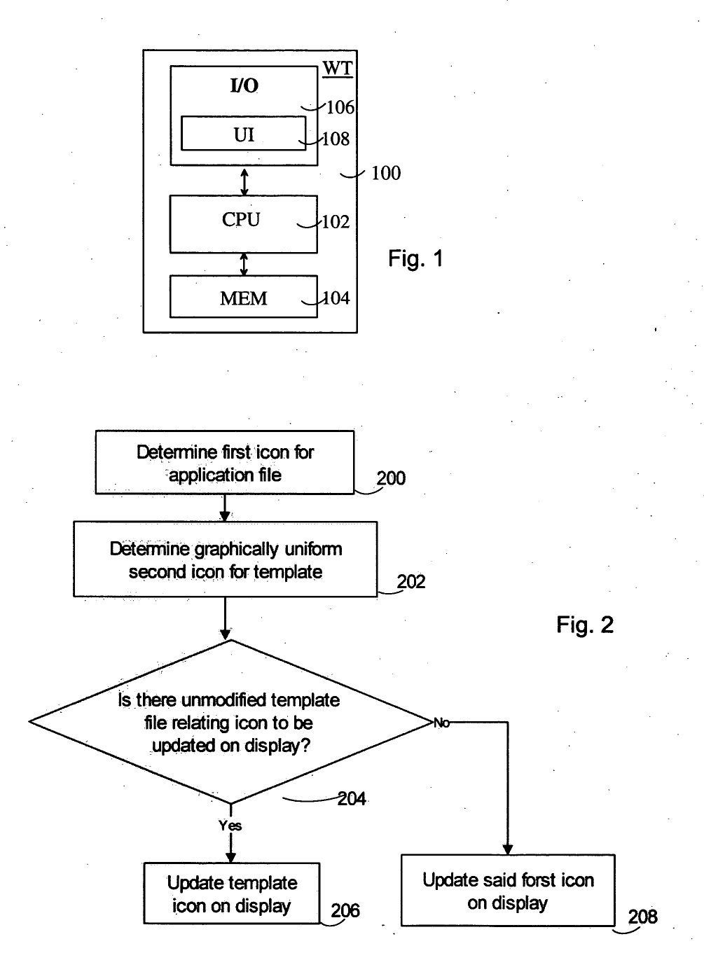

One example of a terminal device, to which the invention can be applied, is a wireless terminal (WT) 100 shown as a simplified block diagram in FIG. 1. The wireless terminal (WT) 100 comprises a central unit (CPU) 102, a memory (MEM) 104 and an I/O system (I/O) 106. Software and other data necessary for using the terminal are stored in the terminal device's memory (MEM) 104 typically comprising read memory, such as ROM (Read Only Memory), and write memory, such as RAM (Random Access Memory), and/or FLASH memory. Through the I/O system (I/O) 106 the terminal communicates externally, for instance with other terminals, a network and a user. The user interface (UI) 108, which is part of the I/O system (I/O) 106, comprises an interface, such as a display, keys and/or a pointing means, a loudspeaker and/or a microphone, through which the terminal and the user can communicate with one another. Data obtained from various components of the terminal are conveyed to the central unit (CPU) 102, which processes the data received.

The user controls the terminal through a visual user interface by pointing out and activating icons representing applications and files. On the display it is typically possible to open several windows which represent application and document icons organized according to a hierarchic arrangement. To avoid problems, which result from the fact that conventionally a wide variety of icons have been used for presenting templates relating to different applications, a procedure for determining template icons is now provided, which is based on making the graphical appearance of most, preferably all template icons employed in the terminal device uniform such that the appearance has a uniform feature that can be intuitively understood to refer to a template. The unification of the appearance can utilize the existing application-specific file icons or create completely new template icons.

FIG. 2 shows a flow chart of the procedure according to the invention. The starting point of the procedure is that the terminal comprises an operating system and at least one application, in which templates can be used. It is desired that the icons of unmodified templates be presented in a uniform manner such that they differentiate from document files that are created on the basis of the templates. Thus, there is initially determined a first icon (200) for a file created with said application, and the icon may have any graphical appearance of a file icon. Thereafter, there is determined at least one second icon (202) for the template-based file created with said application, which icon represents an unmodified template and whose appearance has a common feature with an icon representing a template of at least one second application in the terminal device. Typically, this step already takes place when said application is installed in the terminal device, whereby icon settings are updated both in the application and in the operating system.

The above-described determination (202) can also be carried out by utilizing the existing first file icon of said application, to which is added a feature that unifies the graphical appearance, whereby an icon representing an unmodified template will be obtained.

After performing a display update command in the terminal (e.g. when the terminal is started or when a new window, where said icon is to be shown, is opened on the display) a check is performed (204) in the terminal device to find out what type of file lies behind the icon presented: whether the file corresponding to the file icon shown on the display is a template or a template-based file that has been modified or some other file not based on a template. If the file is a template file, in which no changes have been made, a second icon representing said unmodified template is updated on the display. Whereas, if some other file (a file not based on a template at all or a template-based file with modifications) is concerned, a first file icon, which deviates from the graphical appearance of an unmodified template icon, is updated (208) on the display.

The uniform graphical appearance of template icons shall be such that the template icons can be visualized and easily distinguished from other icons. One visual presentation mode is to add a dashed line to the template icons, preferably around them. Generally, the dashed line is an intuitive way to present things that are intended to serve as models for a shape, such as various chablons and patterns. In this connection the term “dashed line” should be understood in a broad sense to include a discontinuous line consisting of any separate elements (line, dot, bar, figure, etc) and producing perception of a continuous line or shape. The dashed line may also consist of successive elements of different colours, which also produce perception of a continuous line or shape. The basic idea of the invention is not limited, however, to template icons presented by dashed lines, but the template icons can be presented having any uniform graphical appearance.

The graphical appearance of template icons can be redesigned completely either without utilizing the graphics of other icons or utilizing some of the graphics of the existing icons. The latter option may, in some cases, be more illustrative, for instance, if a known graphical item, such as the application logo, representing the application is included in the application-specific template icons. Alternatively, the graphical appearance of the template icons can be rendered uniform such that a graphically unifying feature, such as a dashed line, is added to the existing icons, such as document file icons. This embodiment has an advantage that the template icons need not be designed separately but they are automatically created on the basis of the document file icons when such a template icon is to be presented on the display. Said graphically unifying feature, such as the dashed line, can be added to two- or three-dimensional document file icons and the obtained template icons may include drawings, animations, photographs, three-dimensional objects, text or any other visual elements.

According to one embodiment of the invention the graphically unifying feature, such as a dashed line, can also be presented as a frame for an open template view, for instance. Thus, the user will have immediate, intuitive feedback that the open file actually is a template.

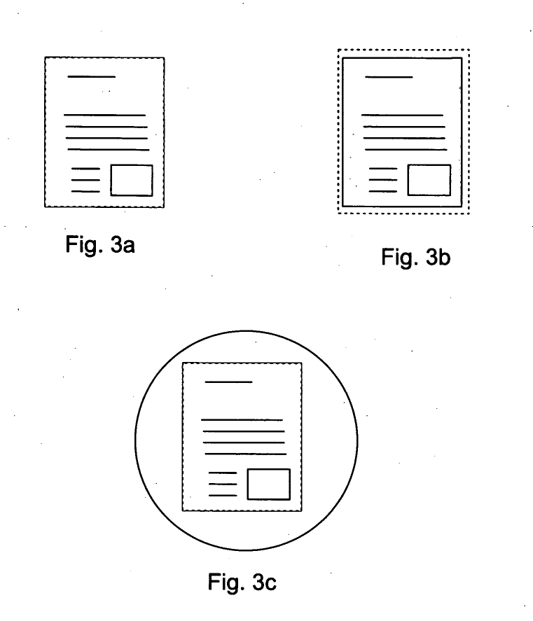

FIGS. 3a, 3b and 3c show template icons according to some embodiments of the invention. FIG. 3a shows a template icon comprising a dashed line that determines the shape of the icon. Because the dashed line is part of the icon also determining its shape, the icon is highly visual and clearly distinguishable from other icons. FIG. 3b shows a template icon comprising a dashed line outside the icon figure. This template icon can be readily produced from an existing document file icon by adding a dashed line outside the icon figure. In this manner template icons can be readily produced from three-dimensional document file icons as well. FIG. 3c shows a template icon comprising a dashed line inside the icon figure, however, in such a manner that the dashed line surrounds the graphics or any visual elements comprised by the icon. The template icon of this type can be used, for instance, when a document file icon comprises, in addition to a visual element, a general background figure, such as a circle or a rectangle.

The method of the invention can be implemented with a data processing device, such as a wireless terminal device of FIG. 1, which comprises a display and a graphical user interface to be presented on the display and at least one application, for which a template is determined. This data processing device comprises means for determining a first icon for a file created with said application; means for determining at least one second icon for a template-based file created with said application, which second icon represents an unmodified template whose graphical appearance comprises a feature that is uniform with the icon representing the unmodified template of at least one second application of the terminal device; means, responsive to a display update command performed in the terminal device, for checking the file type of the file corresponding to the file icon shown on the display; and means for updating on the display the second icon representing said unmodified template, if the file is a template file in which no changes have been made.

Most preferably these means can be implemented as software, which when executed in a central processing unit CPU makes the terminal device perform operations according to the invention. It is possible to divide software SW functions to a plurality of separate software components communicating with one another. The software can be stored in any memory means, for instance, on PC hard disk or CD-ROM disc, from which it can be loaded in the memory MEM of a mobile station MS. The software can also be loaded over the network, for instance, using a TCP/IP protocol stack. It is also possible to use hardware solutions or a combination of hardware and software solutions so as to implement the inventive means.

Thus, when loaded in the data processing device the software program SW is arranged to determine file icons to be presented on the display. A software product of this kind comprises computer program code portion for determining a first icon for a file created with said application; a computer program code portion for determining at least one second icon for a template-based file created with said application, which second icon represents un unmodified template whose graphical appearance comprises a feature that is uniform with the icon representing an unmodified template of at least one second application; a computer program code portion, responsive to a display update command performed in the terminal device, for checking the file type of the file corresponding to the file icon shown on the display; and a computer program code portion for updating on the display the second icon representing said unmodified template, if the file is a template file in which no changes have been made.

It is obvious to a person skilled in the art that as technology advances the basic idea of the invention can be implemented in a variety of ways. The invention and its embodiments are thus not restricted to the above-described examples, but they may vary within the scope of the claims.

1. A method for determining file icons presented on a display in a terminal device comprising an operating system and at least one application, for which a template is determined, the method comprising:
determining a first icon for a file created with said application;
determining at least one second icon for a template-based file created with said application, which second icon represents an unmodified template and whose graphical appearance comprises a feature that is uniform with an icon representing an unmodified template of at least one second application;
checking, in response to a display update of the terminal device, whether the file corresponding to the file icon shown on the display is a template-based file, in which changes have been made; and
updating on the display a second icon representing an unmodified template, if the file is a template file, in which no changes have been made, or alternatively otherwise
updating on the display a first icon, which deviates from the graphical appearance of the icon representing an unmodified template.

2. A method as claimed in claim 1, the method further comprising:
presenting said unmodified template icon comprising a dashed line substantially around the icon.

3. A method as claimed in claim 1, the method further comprising:
creating said unmodified template icon by adding a dashed line around said first predetermined icon.

4. A data processing device, wherein the data processing device comprises:
a display and a graphical user interface shown on the display and at least one application, for which a template is determined;
means for determining a first icon for a file created with said application;
means for determining at least one second icon for a template-based file created with said application, the second icon representing an unmodified template whose graphical appearance comprises a feature that is uniform with the icon representing an unmodified template of at least one second application;
means, responsive to a display update command performed in the terminal device, for checking the file type of a file corresponding to the file icon shown on the display; and
means for updating on the display a second icon representing said unmodified template if the file is a template file, in which no changes have been made.

5. A data processing device as claimed in claim 4, wherein the data processing device further comprises:
means for presenting said unmodified template icon comprising a dashed line substantially around the icon.

6. A data processing device as claimed in claim 4, wherein the data processing device further comprises:
means for creating said unmodified template icon by adding a dashed line around said first predetermined icon.

7. A software product that is configured, when loaded in an electronic device, to determine file icons presented on the display of the device, which device comprises at least one application, for which a template is determined, wherein the software product comprises:
a computer program code portion for determining a first icon for a file created with said application;
a computer program code portion for determining at least one second icon for a template-based file created with said application, which second icon represents un unmodified template whose graphical appearance comprises a feature that is uniform with the icon representing an unmodified template of at least one second application;
a computer program code portion, responsive to a display update command performed in the terminal device, for checking the file type of the file corresponding to the file icon shown on the display; and
a computer program code portion for updating on the display the second icon representing said unmodified template, if the file is a template file in which no changes have been made.

8. A software product as claimed in claim 7, wherein the software product further comprises:
a computer program code portion for presenting said unmodified template icon comprising a dashed line substantially around the icon.

9. A software product as claimed in claim 7, wherein the software product further comprises:
a computer program code portion for creating an icon representing an unmodified template by adding a dashed line around said first predetermined icon.
